(19) United States
(12) Patent Application Publication
(10) Pub. No.: US 2020/0065322 A1
(43) Pub. Date: Feb. 27, 2020

(54) MULTIMEDIA CONTENT TAGS

(71) Applicant: Verance Corporation, San Diego, CA (US)

(72) Inventors: Jian Zhao, San Diego, CA (US); Joseph M. Winograd, San Diego, CA (US)

(21) Appl. No.: 16/667,257

(22) Filed: Oct. 29, 2019

Related U.S. Application Data
(63) Continuation of application No. 13/828,706, filed on Mar. 14, 2013, now abandoned.
(60) Provisional application No. 61/700,826, filed on Sep. 13, 2012.

(51) Int. Cl. G06F 16/41; G06F 16/93; H04N 21/41; H04N 21/845; H04N 21/81; H04N 21/8547

(52) U.S. Cl. CPC G06F 16/41; G06F 16/94; H04N 21/4126; H04N 21/8547; H04N 21/8456; H04N 21/8133; H04N 21/8455

(57) ABSTRACT

Methods, devices and computer program products facilitate enhanced use and interaction with a multimedia content through the use of tags. While a content is being presented by a device, a content identifier and at least one time code associated with one or more content segments are obtained. One or both of the content identifier and the time code can be obtained from watermarks that are embedded in the content, or through computation of fingerprints that are subsequently matched against a database of stored fingerprints and metadata. The content identifier and the at least one time code are transmitted to a tag server. In response, tag information for the one or more content segments is received and one or more tags are presented to a user. The tags are persistently associated with temporal locations of the content segments.

### CROSS REFERENCE TO RELATED APPLICATIONS

This patent application is a continuation of U.S. patent application Ser. No. 13/828,706, filed Mar. 14, 2013, which further claims the benefit of priority to U.S. Provisional Patent Application No. 61/700,826 filed on Sep. 13, 2012. The entire content of the before-mentioned patent applications is incorporated by reference as part of the disclosure of this application.

### FIELD OF INVENTION

The present application generally relates to the field of multimedia content presentation, analysis and feedback.

### BACKGROUND

The use and presentation of multimedia content on a variety of mobile and fixed platforms have rapidly proliferated. By taking advantage of storage paradigms, such as cloud-based storage infrastructures, reduced form factor of media players, and high-speed wireless network capabilities, users can readily access and consume multimedia content regardless of the physical location of the users or the multimedia content.

A multimedia content, such as an audiovisual content, often consists of a series of related images which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc. In some scenarios, such a multimedia content, or portions thereof, may contain only one type of content, including, but not limited to, a still image, a video sequence and an audio clip, while in other scenarios, the multimedia content, or portions thereof, may contain two or more types of content.

### SUMMARY

The disclosed embodiments relate to methods, devices and computer program products that facilitate enhanced use and interaction with a multimedia content through the use of tags. One aspect of the disclosed embodiments relates to a method, comprising obtaining a content identifier and at least one time code associated with one or more content segments of a content that is presented by a first device, transmitting the content identifier and the at least one time code to one or more local or remote tag servers, receiving tag information for the one or more content segments, and presenting one or more tags in accordance with the tag information. The one or more tags are persistently associated with temporal locations of the one or more content segments within the content that is presented by the first device.

In one exemplary embodiment, each time code identifies a temporal location of an associated content segment within the content timeline while in another embodiment, the at least one time code is obtained from one or more watermarks embedded in the one or more content segments. In an exemplary embodiment, obtaining a content identifier comprises extracting an embedded watermark from the content to obtain at least a first portion of the embedded watermark payload corresponding to the content identifier, and transmitting the content identifier comprises transmitting at least the first portion of the embedded watermark payload to the one or more tag servers.

According to another exemplary embodiment, obtaining the content identifier and the at least one time code comprises computing one or more fingerprints from the one or more content segments, and transmitting the computed one or more fingerprints to a fingerprint database. The fingerprint database comprises stored fingerprints and associated content identification information for a plurality of contents to allow determination of the content identifier and the at least one time code by comparing the computed fingerprints with the stored fingerprints. In one exemplary embodiment, the tags are presented on a portion of a display on the first device. In yet another exemplary embodiment, at least a portion of the one or more content segments is received at a second device. In such an embodiment, obtaining the content identifier and the at least one time code is carried out, at least in-part, by the second device, and the one or more tags are presented on a screen associated with the second device.

In one exemplary embodiment, the second device is configured to receive at least the portion of the one or more content segments using a wireless signaling technique. In another exemplary embodiment, the second device operates as a remote control of the first device. Under such scenario, the above note method can further include presenting a graphical user interface that enables one or more of the following functionalities: pausing of the content that is presented by the first device, resuming playback of the content that is presented by the first device, showing the one or more tags, mirroring a screen of the first device and a screen of the second device such that both screens display the same content, swapping the content that is presented on a screen of the first device with content presented on a screen of the second device, and generating a tag in synchronization with the at least one time code. In another exemplary embodiment, the above noted method additionally includes allowing generation of an additional tag that is associated with the one or more content segments through the at least one time code. In one exemplary embodiment, allowing the generation of an additional tag comprises presenting one or more fields on a graphical user interface to allow a user to generate the additional tag by performing at least one of the following operations: entering a text in the one or more fields, expressing an opinion related to the one or more content segments, voting on an aspect of the one or more content segments, and generating a quick tag.

In another exemplary embodiment, allowing the generation of an additional tag comprises allowing generation of a blank tag, where the blank tag is persistently associated with the one or more segments and including a blank body to allow completion of the blank body at a future time. In one exemplary embodiment, the blank tag allows one or more of the following content sections to be tagged: a part the content that was just presented, a current scene that is presented, last action that was presented, and current conversation that is presented. In still another exemplary embodiment, the additional tag is linked to one or more of the presented tags through a predefined relationship and the predefined relationship is stored as part of the additional tag. In one exemplary embodiment, the predefined relationship comprises one or more of: a derivative relationship, a similar relationship and a synchronization relationship.

According to another exemplary embodiment, the above noted method further comprises allowing generation of an additional tag that is indirectly linked to a corresponding tag of a content different from the content that is presented. In such an exemplary method, the indirect linkage of the additional tag is not stored as part of the additional tag but is retained at the one or more local or remote tag servers. In yet another exemplary method, the one or more tags are presented on a graphical user interface as one or more corresponding icons that are superimposed on a timeline of the content that is presented, and at least one icon is connected to at least another icon using a line that is representative of a link between the at least one icon and the at least another icon. In such another exemplary embodiment, the above noted method further includes selectively zooming in or zooming out the timeline of the content to allow viewing of one or more tags with a particular granularity.

In another exemplary embodiment, each of the one or more tags comprises a header section that includes: a content identifier field that includes information identifying the content asset that each tag is associated with, a time code that identifies particular segment(s) of the content asset that each tag is associated with, and a tag address that uniquely identifies each tag. In one exemplary embodiment, each of the one or more tags comprises a body that includes:

a body type field, one or more data elements, and a number and size of the data elements. In another exemplary embodiment, the content identifier and the at least one time code are obtained by estimating the content identifier and the at least one time code from previously obtained content identifier and time code(s).

According to another exemplary embodiment, the above noted method also includes presenting a purchasing opportunity that is triggered based upon the at least one time code. In another exemplary embodiment, the one or more presented tags are further associated with specific products that are offered for sale in one or more interactive opportunities presented in synchronization with the content that is presented. In still another exemplary embodiment, the content identifier and the at least one time code are used to assess consumer consumption of content assets with fine granularity. In yet another exemplary embodiment, the above noted method further comprises allowing discovery of a different content for viewing. Such discovery comprises: requesting additional tags based on one or more filtering parameters, receiving additional tags based on the filtering parameters, reviewing one or more of the additional tags, and selecting the different content for viewing based on the reviewed tags. In one exemplary embodiment, the one or more filtering parameters specify particular content characteristics selected from one of the following: contents with particular levels of popularity, contents that are currently available for viewing at movie theatres, contents tagged by a particular person or group of persons, and contents with a particular type of link to the content that is presented.

In another exemplary embodiment, the above noted method further comprises allowing selective review of content other than the content that is presented, where the selective review includes: collecting one or more filtering parameters, transmitting a request to the one or more tag servers for receiving further tags associated with content other than the content that is presented, the request comprising the one or more filtering parameters, receiving further tag information and displaying, based on the further tag information, one or more further tags associated with content other than the content that is presented, and upon selection of a particular tag from the one or more further tags, automatically starting playback of content other than the content presented, wherein playback starts from a first segment that is identified by a first time code stored within the particular tag.

Another aspect of the disclosed embodiments relates to a method that includes providing at least one time code associated with one or more content segments of a content that is presented by a first device, and transmitting the at least one time code from a requesting device to one or more tag servers. Such a method additionally includes obtaining, at the one or more tag servers based on the at least one time code, a content identifier indicative of an identity of the content, and transmitting, to the requesting device, tag information corresponding the one or more content segments. This method further includes presenting, by the requesting device, one or more tags in accordance with the tag information, where the one or more tags are persistently associated with temporal locations of the one or more content segments within the content that is presented by the first device.

In one exemplary embodiment, the requesting device is a second device that is capable of receiving at least a portion of the content that is presented by the first device. In another exemplary embodiment, the at least one time code represents one of: a temporal location of the one or more content segments relative to the beginning of the content, and a value representing an absolute date and time of presentation of the one or more segments by the first device.

Another aspect of the disclosed embodiments relates to a method that comprises receiving, at a server, information comprising at least one time code associated with a multimedia content, where the at least one time code identifying a temporal location of a segment within the multimedia content. Such a method further includes obtaining a content identifier, the content identifier being indicative of an identity of the multimedia content, obtaining tag information corresponding to the segment of the multimedia content, and transmitting the tag information to a client device, where the tag information allows presentation of one or more tags on the client device, and the one or more tags being persistently associated with the segment of the multimedia content.

In another exemplary embodiment, the information received at the server comprises the content identifier. In one exemplary embodiment, the content identifier is obtained using the at least one time code and a program schedule. In yet another exemplary embodiment, the server comprises a tag database comprising a plurality of tags associated with a plurality of multimedia contents, the tag database also comprising one or more of the following: a number of times a particular tag has been transmitted to another entity, a popularity measure associated with each tag, a popularity measure associated with each multimedia content, a number of times a particular multimedia content segment has been tagged, a time stamp indicative of time and/or date of creation and/or retrieval of each tag, and a link connecting a first tag to a second tag. In another exemplary embodiment, the above noted method also includes receiving, at the server, additional information corresponding to a new tag associated with the multimedia content, generating the new tag based on (a) the additional information, (b) the content identifier and (c) a time code associated with the new tag, and storing the new tag at the server.

Another aspect of the disclosed embodiments relates to a device that includes a processor, and a memory comprising processor executable code. The processor executable code, when executed by the processor, configures the device to obtain a content identifier and at least one time code associated with one or more content segments of a content that is presented by a first device, and transmit the content identifier and the at least one time code to one or more tag servers. The processor executable code, when executed by the processor, also configures the device to receive tag information for the one or more content segments, and present one or more tags in accordance with the tag information, where the one or more tags are persistently associated with temporal locations of the one or more content segments within the content that is presented by the first device.

Another aspect of the disclosed embodiments relates to a device that includes an information extraction component configured to obtain a content identifier and at least one time code associated with one or more content segments of a content that is presented by a first device, and a transmitter configured to transmit the content identifier and the at least one time code to one or more tag servers. Such a device additionally includes a receiver configured to receive tag information for the one or more content segments, and a processor configured to enable presentation one or more tags in accordance with the tag information, where the one or more tags are persistently associated with temporal locations of the one or more content segments within the content that is presented by the first device.

In one exemplary embodiment, the information extraction component comprises a watermark detector configured to extract an embedded watermark from the content to obtain at least a first portion of the embedded watermark payload corresponding to the content identifier, and the transmitter is configured to transmit at least the first portion of the embedded watermark payload to the one or more tag servers. In another exemplary embodiment the information extraction component comprises a fingerprint computation component configured to compute one or more fingerprints from the one or more content segments, and the transmitter is configured to transmit the computed one or more fingerprints to a fingerprint database, where the fingerprint database comprises stored fingerprints and associated content identification information for a plurality of contents to allow determination of the content identifier and the at least one time code by comparing the computed fingerprints with the stored fingerprints.

In another exemplary embodiment, the processor is configured to enable presentation of the tags on a portion of a display on the first device. In yet another exemplary embodiment, the above noted device is configured to obtain at least a portion of the one or more content segments through one or both of a microphone and a camera, where the device further comprises a screen and the processor is configured to enable presentation of the one or more tags on the screen.

Another aspect of the disclosed embodiments relates to a system that includes a second device configured to obtain at least one time code associated with one or more content segments of a content that is presented by a first device, and to transmit the at least one time code to one or more tag servers. Such a system further includes one or more tag servers configured to obtain, based on the at least one time code, a content identifier indicative of an identity of the content, and transmit, to the second device, tag information corresponding the one or more content segments. In connection with such a system, the second device is further configured to allow presentation of one or more tags in accordance with the tag information, where the one or more tags are persistently associated with temporal locations of the one or more content segments within the content that is presented by the first device.

Another aspect of the disclosed embodiments relates to a device that includes a receiver configured to receive information comprising at least one time code associated with a multimedia content, where the at least one time code identifying a temporal location of a segment within the multimedia content. Such a device also includes a processor configured to obtain (a) a content identifier, where the content identifier being indicative of an identity of the multimedia content, and (b) tag information corresponding to the segment of the multimedia content. This devices additionally includes a transmitter configured to transmit the tag information to a client device, where the tag information allows presentation of one or more tags on the client device, and the one or more tags are persistently associated with the segment of the multimedia content.

In one exemplary embodiment, the device further includes a tag database comprising a plurality of tags associated with a plurality of multimedia contents, the tag database also comprising one or more of the following: a number of times a particular tag has been transmitted to another entity, a popularity measure associated with each tag, a popularity measure associated with each multimedia content, a number of times a particular multimedia content segment has been tagged, a time stamp indicative of time and/or date of creation and/or retrieval of each tag, and a link connecting a first tag to a second tag. In another exemplary embodiment such a device also includes a storage device, where the receiver is further configured to receive additional information corresponding to a new tag associated with the multimedia content, and the processor is configured to generate the new tag based on at least (a) the additional information, (b) the content identifier and (c) a time code associated with the new tag, and to store the new tag at storage device.

Another aspect of the disclosed embodiments relates to a system that includes a second device, and a server. In such a system, the second device comprises: (a) an information extraction component configured to obtain a content identifier and at least one time code associated with one or more content segments of a content that is presented by a first device, where the at least one time code identifies a temporal location of a segment within the content, (b) a transmitter configured to transmit the content identifier and the at least one time code to one or more servers, (c) a receiver configured to receive tag information for the one or more content segments, and (d) a processor configured to enable presentation one or more tags in accordance with the tag information, where the one or more tags are persistently associated with temporal locations of the one or more content segments within the content that is presented by the first device. In this system the server includes (e) a receiver configured to receive information transmitted by the second device, (f) a processor configured to obtain the at least one time code, the content identifier, and tag information corresponding to the one or more segments of the content, and (g) a transmitter configured to transmit the tag information to the second device.

Another aspect of the disclosed embodiments relates to a method that includes obtaining, at a second device, a content identifier and at least one time code associated with one or more content segments of a content that is presented by a first device, where the at least one time code identifies a temporal location of a segment within the multimedia content, and the content identifier is indicative of an identity of the multimedia content. This particular method further includes transmitting, by the second device, the content identifier and the at least one time code to one or more tag servers, receiving, at the one or more servers, information comprising the content identifier and the at least one time code, and obtaining, at the one or more servers, tag information corresponding to one or more segments of the content. This method additionally includes transmitting, by the one or more servers, the tag information to a client device, receiving, at the second device, tag information for the one or more content segments, and presenting one or more tags in accordance with the tag information, where the one or more tags are persistently associated with temporal locations of the one or more content segments within the content that is presented by the first device.

Another aspect of the disclosed embodiments relates to a computer program product, embodied on one or more non-transitory computer media, comprising program code for obtaining a content identifier and at least one time code associated with one or more content segments of a content that is presented by a first device. The computer program product further includes program code for transmitting the content identifier and the at least one time code to one or more tag servers, program code for receiving tag information for the one or more content segments, and program code for presenting one or more tags in accordance with the tag information, where the one or more tags are persistently associated with temporal locations of the one or more content segments within the content that is presented by the first device.

Another aspect of the disclosed embodiments relates to a computer program product, embodied on one or more non-transitory computer media, comprising program code for providing at least one time code associated with one or more content segments of a content that is presented by a first device, and transmitting the at least one time code from a requesting device to one or more tag servers. The computer program product also includes program code for obtaining, at the one or more tag servers based on the at least one time code, a content identifier indicative of an identity of the content, and transmitting, to the requesting device, tag information corresponding the one or more content segments. The computer program product additionally includes program code for presenting, by the requesting device, one or more tags in accordance with the tag information, where the one or more tags are persistently associated with temporal locations of the one or more content segments within the content that is presented by the first device.

Another aspect of the disclosed embodiments relates to a computer program product, embodied on one or more non-transitory computer media, comprising program code for receiving, at a server, information comprising at least one time code associated with a multimedia content, where the at least one time code identifies a temporal location of a segment within the multimedia content. The computer program product also includes program code for obtaining a content identifier, where the content identifier is indicative of an identity of the multimedia content, and program code for obtaining tag information corresponding to the segment of the multimedia content. The computer program product additionally includes program code for transmitting the tag information to a client device, where the tag information allows presentation of one or more tags on the client device, and the one or more tags are persistently associated with the segment of the multimedia content.

Another aspect of the disclosed embodiments relates to a computer program product, embodied on one or more non-transitory computer media, comprising program code for obtaining, at a second device, a content identifier and at least one time code associated with one or more content segments of a content that is presented by a first device, where the at least one time code identifies a temporal location of a segment within the multimedia content, and where the content identifier is indicative of an identity of the multimedia content. The computer program product also includes program code for transmitting, by the second device, the content identifier and the at least one time code to one or more tag servers, and program code for receiving, at the one or more servers, information comprising the content identifier and the at least one time code. The computer program product further includes program code for obtaining, at the one or more servers, tag information corresponding to one or more segments of the content, and program code for transmitting, by the one or more servers, the tag information to a client device. The computer program product additionally includes program code for receiving, at the second device, tag information for the one or more content segments, and program code for presenting one or more tags in accordance with the tag information, where the one or more tags are persistently associated with temporal locations of the one or more content segments within the content that is presented by the first device.

### BRIEF DESCRIPTION OF THE DRAWINGS

FIG. 1 illustrates a set of tags associated with a multimedia content in accordance with an exemplary embodiment.

FIG. 2 illustrates a user tagging system in accordance with an exemplary embodiment.

FIG. 3 illustrates a system including a user interface that can be used to create, present, discover and/or modify tags in accordance with an exemplary embodiment.

FIG. 4 illustrates a system including a user interface that can be used to create, present, and/or modify tags in accordance with another exemplary embodiment.

FIG. 5 illustrates a system in which a first and/or a second device can be used to create, present, discover, and/or modify tags in accordance with an exemplary embodiment.

FIG. 6 illustrates a plurality of tag links in accordance with an exemplary embodiments.

FIG. 7 illustrates indirect tag links established for different versions of the same content title in accordance with an exemplary embodiment.

FIG. 8 illustrates a layout of a plurality of tags on a content timeline in accordance with an exemplary embodiment.

FIG. 9 illustrates a set of operations for synchronous usage of tags in accordance with an exemplary embodiment.

FIG. 10 illustrates a set of operations for selective reviewing of tags in accordance with an exemplary embodiment.

FIG. 11 illustrates a set of operations that can be carried out to perform content discovery in accordance with an exemplary embodiment.

FIG. 12 illustrates a set of operations that can be carried out at a tag server in accordance with an exemplary embodiment.

FIG. 13 illustrates a simplified diagram of an exemplary device within which various disclosed embodiments may be implemented.

FIG. 14 illustrates a simplified diagram of another exemplary device within which various disclosed embodiments may be implemented.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the words “example” and “exemplary” are used to mean serving as an example, instance, or illustration. Any embodiment or design described herein as “example” or “exemplary” is not necessarily to be construed as preferred or advantageous over other embodiments or designs. Rather, use of the words example and exemplary is intended to present concepts in a concrete manner.

Time-based annotations are usually associated with a point or a portion of a media content based on the timing information stored in the content such as timestamps that are stored as part of a metadata field and are multiplexed with content and/or derived from the content from, for example, the frame number in a video stream. However, these methods share a common problem: such association is neither reliable nor permanent. For example, once the content is transformed into a different form through, for example, transcoding, frame rate change, and the like, such timing information, which associates tags to a content portion, is either lost or is rendered inaccurate. In addition, these methods can require additional metadata channels that can limit the bandwidth of the main content, and can require additional computational resources for managing and transmitting metadata channels. Annotations in some annotation systems are stored in an associated instance of the media content. These annotations are only available to the consumers of such specific instance, and can be lost after transformations such as transcoding of such instance.

The disclosed embodiments provide solutions to the aforementioned problems and further facilitate media content distribution, consumption and related services, such as the creation, enriching, sharing, revision and publishing of media content, using reliable and persistent tagging techniques. The tags that are produced in accordance with the disclosed embodiments are associated to a specific point or portion of the content to enable enhanced content-related services. These tags are permanently or persistently associated with a position or segment of the content and contain relevant information about such content position or segment. These tags are stored in tag servers and shared with all consumers of the media content. In describing the various embodiments of the present application, the terms content, media content, multimedia content, content asset and content stream are sometimes used interchangeably to refer to an instance of a multimedia content. Such content may be uniquely identified using a content identifier (CID). Sometimes the terms content, content asset, content title or title are also interchangeably used to refer to a work in an abstract matter, regardless of its distribution formats, encodings, languages, composites, edits and other versioning.

In some example embodiments, the CID is a number that is assigned to a particular content when such a content is embedded with watermarks using a watermark embedder. Such watermarks are often substantially imperceptibly embedded into the content (or a component of the content such as an audio and/or video component) using a watermark embedder. Such watermarks include a watermark message that is supplied by a user, by an application, or by another entity to the embedder to be embedded in the content as part of the watermark payload. In some embodiments, the watermark message includes a time code (TC), and/or a counter, that may be represented as a sequence of numeric codes generated at regular intervals by, for example, a timing system or a counting system during watermark embedding. The watermark message may undergo several signal processing operations, including, but not limited to, error correction encoding, modulation encoding, scrambling, encryption, and the like, to be transformed into watermark symbols (e.g., bits) that form at least part of the watermark payload. Watermark payload symbols are embedded into the content using a watermark embedding algorithm. In some examples, the term watermark signal is used to refer to the additional signal that is introduced in the content by the watermark embedder. Such a watermark signal is typically substantially imperceptible to a consumer of the content, and in some scenarios, can be further modified (e.g., obfuscated) to thwart analysis of the watermark signal that is, for example, based on differential attack/analysis.

The embedded watermarks can be extracted from the content using a watermark extractor that employs one or more particular watermark extraction techniques. Such watermark embedders and extractors can be implemented in software, hardware, or combinations thereof.

A tag provides auxiliary information associated with a specific position or segment of a specific content and is persistently or permanently attached to that specific content position or segment. In accordance with some embodiments, such associations are made permanent through content identifier and time identifiers that are embedded into the content as digital watermarks. Such watermark-based association allows any device with watermark detection capability to identify the content and the temporal/spatial position of the content segment that is presented without a need for additional data streams and metadata.

Additionally, or alternatively, in other exemplary embodiments, other content identification techniques such as fingerprinting can be used to effect such association. Fingerprinting techniques rely on analyzing the content on a segment-by-segment basis to obtain a computed fingerprint for each content segment. Fingerprint databases are populated with segment-wise fingerprint information for a plurality of contents, as well as additional content information, such as content identification information, ownership information, copyright information, and the like. When a fingerprinted content is subsequently encountered at a device (e.g., a user device equipped with fingerprint computation capability and connectivity to the fingerprint database), fingerprints are computed for the received content segments and compared against the fingerprints that reside at the fingerprint database to identify the content. In some embodiments, the comparison of fingerprints computed at, for example, a user device, and those at the fingerprint database additionally provides content timeline. For instance, a fingerprint computed for a content segment at a user device can be compared against a series of database fingerprints representing all segments of a particular content using a sliding window correlation technique. The position of the sliding window within the series of database fingerprints that produces the highest correlation value can represent the temporal location of the content segment within the content.

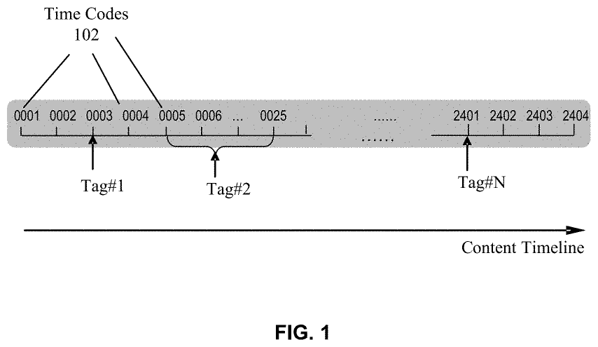

FIG. 1 illustrates a set of tags associated with a content in accordance with an exemplary embodiment. For ease of understanding, the sequential time codes 102 (e.g., 0001, 0002, . . . 2404) in FIG.1 are positioned at equal distances within the content timeline and Tag #1, Tag #2 and Tag #N are associated with different time code or time codes of the content. In particular, Tag #1 associates with a content timeline location corresponding to the time code value 0003, Tag#2 associates with a segment starting at a timeline point corresponding to the time code value 0005 and ending at a timeline point corresponding to the time code value 0025, and Tag #N associates with a timeline point of the content corresponding to the time code value 2401. As noted earlier, the time codes can be provided through watermarks that are embedded in the content. In addition to the time codes, a content identifier can also embedded throughout the content at intervals that are similar or different from time code intervals.

The tags that are described in the disclosed embodiments may be created by a content distributor, a content producer, a user of the content, or any third-party during the entire life cycle of the content from production to consumption and archive. In some embodiments, before a tag is published (i.e., before it is made available to others), its creator may edit the tag, including its header and body. In some embodiments, after a tag is published, its header and body may not be changed. However, in some embodiments, the creator/owner of the tag may expand the body of the tag, or delete the entire tag.

A tag can include a header section and an optional body section. The header section of the tag may include one or more of the following fields:
A content identifier (CID) field, which includes information that identifies the content asset that the tag is associated with.
A time code (TC) field, which identifies a segment of the content asset that a tag is associated with. For example, the start and end of the watermark signal that carries a TC, or the start and end of the watermark signals that carry a sequence of TCs, can correspond to the starting point and ending point, respectively, of the identified content segment.
A tag address field, which uniquely identifies each tag in the tagging system.
An author field, which identifies the person who created the tag. This field can, for example, include the screen name or login name of the person.
A publication time field, which specifies the date and time of publication of the tag.
A tag category field, which specifies the tag type. For example, this field can specify if the tag is created based on predefined votes, by critics, from derivative work, for advertisements, etc.
A tag privacy field, which specifies who can access the tag. For example, this field can specify whether the tag can be accessed by the author only, by friends of the author (e.g., in a social network) or by everyone.
A start point field, which specifies the starting point of the segment that is associated with this tag in the content timeline. For example, this field can contain a TC number, e.g., 0024.
An end point field, which specifies the ending point of the segment that is associated with this tag in a content timeline. For example, this field can contain a TC number, e.g., 0048.
A ratings field, which specifies the number of votes in each rating category such as “like”, “don't like”, “funny”, “play of the day”, “boring”, “I want this,” etc.
A popularity field, which specifies, for example, the number of links to the tag (i.e., these links are created by other authors), and the number of viewings of the tag, etc.
A link field, which includes a list of addresses of the tags that are linked to this tag through one of the predefined relationships.

It should be noted that the above fields within the tag's header section only present exemplary fields and, therefore, additional or fewer fields can be included within the header section.

The body section of a tag can include one or more data elements such as textual data, multimedia data, software programs, or references to such data. Examples of the data elements in the tag's body can include, but are not limited to:
Textual comments.
A URL that specifies a video stream on, for example, a tag server or media server.
A timeline reference to the content asset being tagged.
A URL that specifies a video stream on, for example, a tag server or media server and a reference to a specific timeline point in such video stream.
A URL that specifies a photo album or a photo in an album on, for example, a tag server or picture server.
A URL that specifies a photo album on, for example, a tag server or on picture server.
A program that runs on a client device to provide customized services such as interactive gaming.
A URL that specifies a content streaming sever to provide the same content being viewed on a first screen (“TV Everywhere”), or supplement content.

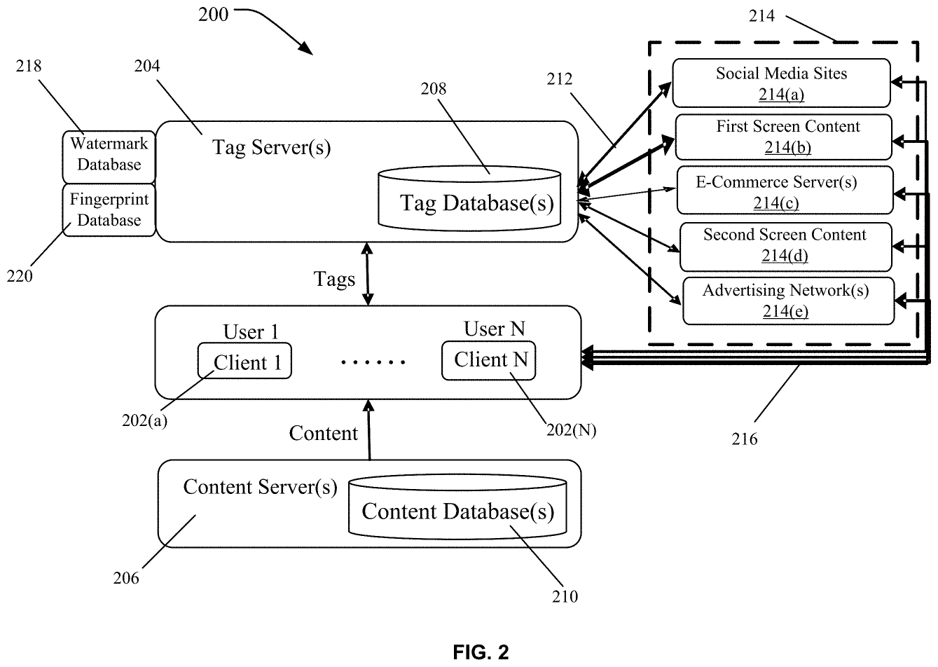

FIG. 2 illustrates an architecture for a user tagging system 200 in accordance with an exemplary embodiment. One or more clients 202(a) through 202(N) can view, navigate, generate and/or modify tags that are communicated to one or more tag servers 204. The tags that are communicated to the tag server(s) can be stored in one or more tag databases 208 that are in communication with the tag server(s) 204. The tag server(s) 204 and/or tag database(s) 208 may reside at the same physical location or at different physical locations (e.g., in distributed computing or cloud computing configuration). The tags may be communicated from the tag server(s) 204 to one or more clients 202(a) through 202(N). In some examples, one or more users (such as User 1 through User N depicted in FIG. 2) utilize one or more clients 202(a) through 202(N) to, for example, view the presented content and associated tags, generate tags, an/or modify the generated tags (if permitted to do so). Each client 202(a) through 202(N) can be a device (e.g., a smartphone, tablet, laptop, game counsel, etc.) with the corresponding software that is runs on the client device (e.g., an application, a webpage, etc.). Alternatively, or additionally, the appropriate software may be running on a remote device. Each client 202(a) through 202(N) can have the capability to allow a content to be presented to the user of each client 202(a) through 202(N) and can allow a user through, for example, a keyboard, a mouse, a voice control system, a remote control device and/or other user interfaces, view, navigate, generate and/or modify tags associated with the content.

Referring again to FIG. 2, one or more content servers 206 is configured to provide content to one or more clients 202(a) through 202(N). The content server(s) 206 are in communication with one or more content database(s) 210 that store a plurality of contents to be provided to one or more clients 202(a) through 202(N). The content server(s) 206 and/or content database(s) 210 may reside at the same physical location or at different physical locations (e.g., in distributed computing or cloud computing configuration). In some embodiments, the content and the associated tags may be stored together at one or more databases. Moreover, in some embodiments, the content that is provided to one or more clients 202(a) through 202(N) are stored locally at the client, such as on magnetic, optical or other data storage devices.

Also shown in FIG. 2 are watermark database 218 and fingerprint database 220, one or both of which can be optionally included as part of the user tagging system 200. The watermark database 218 can include metadata associated with a watermarked content that allows identification of a content, the associated usage policies, copyright status and the like. For instance, the watermark database 218 can allow determination of a content's title upon receiving content identification information that is, for example, embedded in a content as part of a watermark payload. The fingerprint database 220 includes fingerprint information for a plurality of contents and the associated metadata to allow identification of a content, the associated usage policies, copyright status and the like. The watermark database 218 and/or the fingerprint database 220, if implemented, can be in communication with one or more of the tag servers 204, and/or one or more clients 202(a) through 202(N) through one or more communication links (not shown). In some embodiments, watermark database 218 and/or the fingerprint database 220 can be implemented as part of the tag server(s) 204.

FIG. 2 also illustrates one or more additional tag generation/consumption mechanisms 214 that are in communication with the tag server(s) 204 through the link(s) 212. These additional tag generation/consumption mechanisms 214 can, for example, include any one or more of: social media sites 214(a), first screen content 214(b), E-commerce server(s) 214(c), second screen content 214(d) and advertising network(s) 214(e). The links 212 are configured to provide a two-way communication capability between the additional tag generation/consumption mechanisms 214 and the tag server(s) 204. Additionally, or alternatively, the additional tag generation/consumption mechanisms 214 may be in communication with one or more of the clients 202(a) through 202(N) through the links 216. The interactions between the additional tag generation/consumption mechanisms 214 and the clients 202(a) through 202(N) will be discussed in detail in the sections that follow.

Communications between various components of FIG. 2 may be carried out using a wired and/or wireless communication methods, and may include additional commands and procedures, such as request-response commands to initiate, authenticate and/or terminate secure (e.g., encrypted) or unsecure communications between two or more entities.

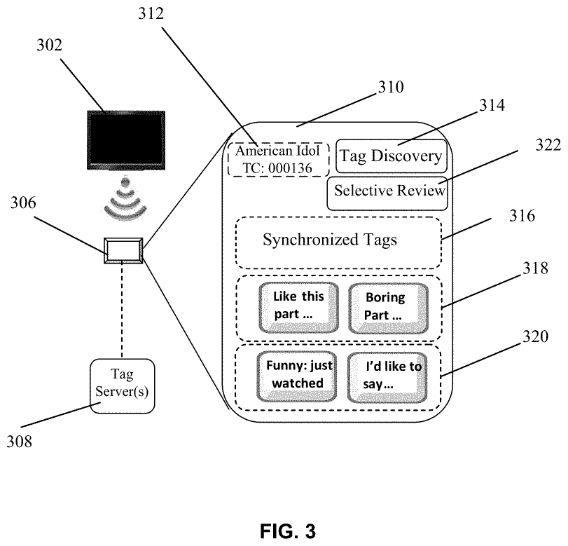

As noted in connection with FIG. 2, a user can generate and/or modify a tag by utilizing a user interface of one or more of the clients 202(a) through 202(N). FIG. 3 illustrates a system including a user interface 310 that can be used to navigate, create and/or modify a tag in accordance with an exemplary embodiment. The diagram in FIG. 3 shows an exemplary scenario where a first content is presented to a user on a first device 302. For example, such a first content can be a broadcast program that is being viewed on a television set. A portion and/or a component of the first content (such as audio component) is received at a second device 306, which is in communication with one or more tag server(s) 308. The exemplary scenario that is depicted in FIG. 3 is sometimes referred to as “second screen content” since the second device 306 provides an auxiliary content on a different display than the first content.

FIG. 3 further shows an exemplary user interface 310 that is presented to the user on the second device 306. In some embodiments, the user interface 310 is displayed on the screen of the second device (or on a screen that is in communication with the second device 306) upon user's activation of a software program (e.g., an application) on the second device 306. Additionally, or alternatively, the second device can be configured to automatically present the user interface 310 upon detection of a portion of the first content. For example, the second device 306 can be equipped with a watermark extractor. In this example, upon receiving an audio portion of the first content (through, for example, a microphone input), the watermark extractor is triggered to examine the received audio content and to extract embedded watermarks. Analogously, watermark detection can be carried out on a video portion of the first content that is received through, for example, a video camera that part of, or is in communication with, the second device 306.

The exemplary user interface 310 that is shown in FIG. 3 can include a section 312 that displays the title and time code values of the first content. The displayed title and time code value(s) can, for example, be obtained from watermarks that are embedded in the first content. For instance, upon reception of a portion of the first content and extraction of embedded watermarks that include a CID, the content title can be obtained from the tag sever 308 based on the detected CID. The current time code (e.g., TC=000136) is associated with the section of the first content that is presented by the first device 302. The TC value can be periodically updated as the first content continues to be presented by the first device 302. The exemplary user interface 310 of FIG. 3 also includes a tag discovery 314 button that allows the user to search, discover and navigate the tags associated with other sections of the content that is being present or sections of a plurality of other contents. The exemplary user interface 310 of FIG. 3 further includes a selective review 322 button that allows the user to selectively review the tagged segments of the content that is presented. An area 316 of the user interface 310 can be used to display synchronized tags, which can be presented based on information received from the tag server 308 in response to receiving the current TC. The synchronized tags can be automatically updated when the TC value is updated. For example, as the first content is presented by the first device 302, the TC and CID values are extracted from the content that is received at the second device 306 and are transmitted to the one or more tag servers 308 to obtain the associated tag information from the tag server's 308 tag database. The synchronized tags are then presented (e.g., as an audio, video, text, etc.) to the user on area 318 of the second device user interface 310. This process can be repeated once a new TC becomes available during the presentation.

The exemplary user interface 310 of FIG. 3 also illustrates an area 318 that includes quick tag buttons (e.g., “Like this part . . . ” and “Boring Part”), as well as an area 320 that is reserved for blank tag buttons (e.g., “Funny: just watched” and “I'd like to say . . . ”). Quick tags allow the user to instantly vote on the content segment that is being viewed or has just been viewed. For example, one quick tag button may be used to create an instant tag “Like this part . . . ” to indicate that the user likes the particular section of the first content, while another quick tag button “Boring Part” may be used to convey that the presented section is boring. The tags created by the quick tag buttons typically do not include a tag body. Blank tags allow the user to create a tag that is associated with the content segment that is being viewed or has just been viewed. The tags created by the blank tag buttons can be edited and/or published by the user at a later time.

Referring back to FIG. 3, when tags are created by the second device 306, the second device 306 may need to continuously receive, analyze and optionally record portions of the first content (e.g. a portion of the audio component of the first content) that are presented by the first device 302. In some applications, these continuous operations can tap the computational resources of the second device 306. To remedy this situation, in some embodiments, the processing burden on the second device 306 is reduced by shortening the response time associated with watermark extractor operations.

In particular, in one exemplary embodiment, the received content (e.g., the received audio component of the content) at the second device 306 is periodically, instead of continuously, analyzed and/or recorded to carry out watermark extraction. In this case, the watermark extractor retains a memory of extracted CID and TC values to predict the current CID and TC values without performing the actual watermark extraction. For example, at each extraction instance, the extracted CID value is stored at a memory location and the extracted TC value is stored as a counter value. Between two extraction instances, the counter value is increased according to the embedding interval of TCs based on an elapsed time as measured by a clock (e.g., a real-time clock, frame counter, or timestamp in the content format) at the second device 306. Such an embedding interval is a predefined length of content segment in which a single TC is embedded. For example, if TC values are embedded in the content every 3 seconds, and the most recently extracted TC is 100000 at 08:30:00 (HH:MNI:SS), the TC counter is incremented to 100001 at 08:30:03, to 100002 at 08:30:06, and so on, until the next TC value is extracted by the watermark extractor. In the above-described scenario, linear content playback on the first device 302 is assumed. That is, the content is not subject to fast-forward, rewind, pause, jump forward or other “trick play” modes.

In another exemplary embodiment, the predicted TC value can be verified or confirmed without a full-scale execution of watermark extraction. For example, the current predicted counter value can be used as an input to the watermark extractor to allow the extractor to verify whether or not such a value is present in the received content. If confirmed, the counter value is designated as the current TC value. Otherwise, a full-scale extraction operation is carried out to extract the current TC value. Such verification of the predicted TC value can be performed every time a predicted TC is provided, or less often. It should be noted that, by using the predicted counter value as an input, the watermark extractor can verify the presence of the same TC value in the received content using hypothesis testing, which can result in considerable computational savings, faster extraction and/or more reliable results. That is, rather than assuming an unknown TC value, the watermark extractor assumes that a valid TC (i.e., the predicted TC) is present, and verifies the validity of this assumption based on its analysis of the received content.

According to some exemplary embodiments, a tag can also be created on the first device, such as the device 302 that is shown in FIG. 3. The content that is presented on the first device 302 can include, but is not limited to, television programs received through terrestrial broadcasts, satellites or cable networks, video-on-demand (VOD) content, streaming content, content retrieved from physical media, such as optical discs, hard drives, etc., and other types of content. The first device can be a television set, a smart phone, a tablet, and the like.

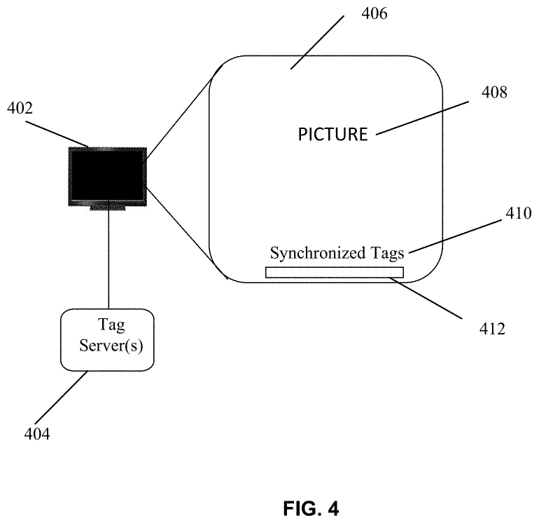

FIG. 4 illustrates a system including a user interface 406 that can be used to create and/or modify a tag in accordance with an exemplary embodiment. In the exemplary diagram of FIG. 4, the content, such as a picture 408, is presented by the first device 402 on a user interface 406. The first device 402 is also in communication with one or more tag servers 404 and allows the display of synchronized tags 410 on the user interface 406 in a similar manner as described in connection with FIG. 3. The exemplary scenario that is depicted in FIG. 4 is sometimes referred to as the “first screen content.” For devices that support multiple windows on the user interface 406, such as personal computers (PCs), tablets and Internet TV supporting picture-in-picture or multi-windows, tags may be created on a separate window from the content viewing window. In such an exemplary scenario, tags may be created or modified in a similar manner as described in connection with the second screen content of FIG. 3.

In some embodiments, the user interface 406 of FIG. 4 also includes a tag input area 412 that allows a user to create and/or modify a tag (e.g., enter a text) associated with content segments that are presented by the first device 402. For example, once the user moves the mouse over the synchronized tags or presses a specific button on a remote control, the tag input area 412 is displayed, which allows the user to enter text and other information for tag creation. The first device 402 is able to associate the created tags with particular content segments based on the time codes (TCs) and content identifiers (CIDs) that are extracted from the content. To this end, in some embodiments, the first device is equipped with a watermark extractor in order to extract information-carrying watermarks from the content. As noted earlier, watermark extraction may be conducted continuously or intermittently.

In some exemplary embodiments, tag creation on the first device 402 is carried out using an application or built-in buttons (e.g., a “Tag” button, a “Like” button, etc.) on a remote control device that can communicate with the first device 402. In such a scenario, a user can, for example, press the “Tag” button on the remote control to activate the watermark extractor of the first device 402. Once the watermark extractor is enabled, the user may press the “Like” button to create a tag for the content segment being viewed to indicate the user's favorable opinion of the content. Alternatively, in some embodiments, pressing the “Tag” button can enable various tagging functionalities using the standard remote control buttons. For example, the channel up/down buttons on the remote control may be used to generate “Like/Dislike” tags, or channel number buttons may be used to provide a tag with a numerical rating for the content segment that is being viewed.

In some embodiments, both a first and a second device are used to navigate, create and/or modify tags. In particular, when a second device can remotely control at least part of the operations of the first device, a tag may be created using both devices. Such a second device may be connected to the first device using a variety of communication techniques and procedures, such as infrared signaling, acoustic coupling, video capturing (e.g., via video camera), WiFi or other wireless signaling techniques. They can also communicate via a shared remote server that is in communication with both the first and the second device. In these example embodiments, the watermark extractor may be incorporated into the first device, the second device, or both devices, and the information obtained by one device (such as CID, TC, tags from tag servers, tags accompanying the content and/or the fingerprints of the content presented) can be communicated to the other device.

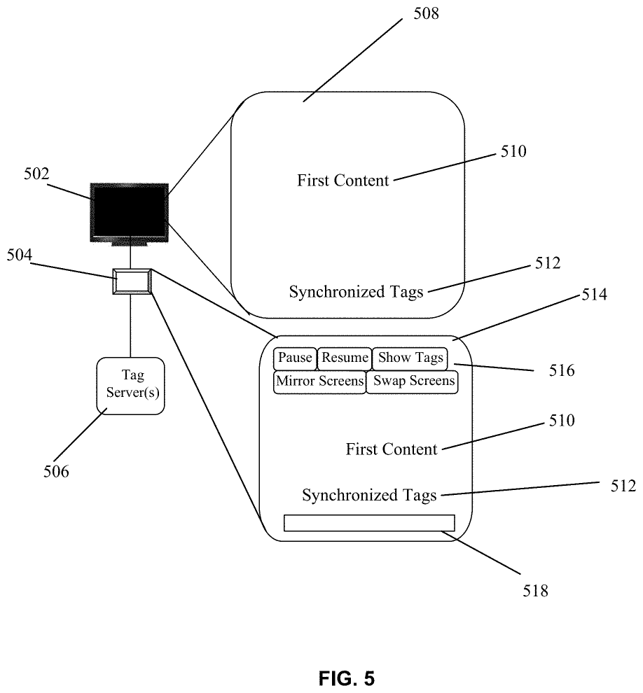

FIG. 5 illustrates a system in which either a first device 502 or a second device 504 can be used to navigate, create and/or modify a tag in accordance with an exemplary embodiment. The first device 502 and/or the second device 504 are connected to one or more tag servers 506 that allow the presentation of synchronized tags 512, in a manner that was described in connection with FIGS. 3 and 4, on either or both of the first user interface 508 and a second user interface 514. The first content 510 that is presented by the first device 502 can be viewed on the user interface 508 of the first device 502, or on the user interface 514 of the second device 504. The user interface 514 of the second device 504 also includes one or more remote control 516 functionalities, such as pause, resume, show tags, mirror tags and swap screens, that allow a user to control the presentation the first content 510, synchronized tags 512 and other tagging and media functionalities. In particular, the Pause and Resume functionalities stop and start the presentation of the first content 510, respectively. The Show Tags functionality controls the display of the synchronized tags 512, the Mirror Screens functionality allows the first user interface 508 (and/or the content that is presented on the first interface 508) to look substantially identical to that of the second user interface 514 (although some scaling, interpolation, and cropping may need to be performed due to differences in size and resolution of the displays of first device 502 and second device 504). The Swap Screens functionality allows swapping of the first user interface 508 with the second user interface 514. The second user interface 514 can also include a tag input area 518 that allows a user to create and/or modify tags associated with content segments that are presented.

Using the exemplary configuration of FIG. 5, a user can watch, for example, a time-shifted content (e.g., a content that is recorded on a DVR for viewing at a future time) on the first user interface 508 (e.g., a television display) using a second device 504 (e.g., a tablet or a smartphone) as a remote control. In such a configuration, the user can pause the playback on the TV using an application program that is running on the second device 504, and can create tags, either in real-time as the content is being played, or while the content is paused. While the user is creating a tag, or after the user has finished creating the tag, the existing synchronized tags 512 associated with the current segments of the first content 510 can be obtained from the tag server(s) 506 and presented on the first user interface 508 and/or on the second interface 514. In some embodiments, while the first content 510 is presented on the first user interface 508, the user can use the second user interface 514 to browse the existing synchronized tags 512 and to, for example, watch a multimedia content (e.g., a derivative content or a mash-up) that is contained within a synchronized tag 512 (e.g., through a URL) on at least a section of the second interface 514 or the first interface 508. Again, the first device 502 and second device 504 are connected to each other and the tag server(s) 506 using any one of a variety of wired and/or wireless communication techniques.

In some embodiments, one or more tags associated with a content are created after the content is embedded with watermarks but before the content is distributed. Such tags may be created by, for example, content producers, content distributors, sponsors (such as advertisers) and content previewers (such as critics, commentators, super fans, etc.). In some scenarios, the tags that are created in this manner are manually associated with particular content segments by, for example, specifying the start and optional end points in content timeline, as well as manually populating other fields of the tag. In other scenarios, a tag authoring tool automatically detects the interesting content segments (e.g., an interesting scene, conversation or action) with video search/analysis techniques, and creates tags that are permanently associated with such segments by defining the start and end points in these tags using the embedded content identifier (CID) and time codes (TCs) that are extracted from such content segment(s).

As noted in connection with FIGS. 3 through 5, tags can be created by a user of the content as the content is being continuously presented. Continuous presentation of the content can, for example, include presentation of the content over broadcast or cable networks, streaming of a live event from a media server, and some video-on-demand (VOD) presentations. During a continuous presentation, the user may not have the ability to control content playback, such as pause, rewind, fast forward, reverse or forward jump, stop, resume and other functionalities that are typically available in time-shifted viewing. Therefore, the users can have a limited ability to create and/or modify tags during continuous viewing of the presented content.

In some embodiments, tag placeholders or blank tags are created to minimize distraction of the user during content viewing by simply pressing a button (e.g., a field on a graphical user interface that is responsive to a user's selection and/or a user's input in that field). Such a button allows particular sections of the content to be tagged by, for example, specifying the starting point and/or the ending point of the content sections associated with a tag. In one exemplary embodiment, one or more buttons (e.g., a “Tag the part just presented” button, a “Tag the last action” button, or a “Tag the current conversation” button, etc.) are provided that set the end point of the blank tag to the current extracted time code (TC) value. In another exemplary embodiment, a button can obtain the content identifier (CID) and the current extracted TC, and send them to a tag server to obtain start and end TCs associated with the current scene, conversation or action, and create a blank tag with the obtained start and end point TCs. In such a case, it is assumed that such a scene, conversation or action has been identified and indexed based on TCs at the tag server. In another exemplary embodiment, a button performs video search and analysis to locally (e.g., at the user device) identify the current scene, conversion or action, and then to obtain the CID and the start/end TCs from the identified segments of the current scene, conversation or action for the blanket tags.

Once one or more blank tags have been created during the presentation of a content, the user may complete the contents of the blank tags at a future time, such as during commercials, event breaks and/or after the completion of content viewing. Completion of the blanks tag can include filling out one or more of the remaining fields in the tags' header and/or body. The user may subsequently publish the tags to a tag server and/or store the tags locally for further editing.

In some exemplary embodiments, tags may be published without time codes (TCs) and/or content identifiers (CIDs). For example, a legacy television set or PC may not be equipped with a watermark extractor and/or a content may not include embedded watermarks. In such cases, the CID and TCs in the tags can be calculated or estimated before these tags can become available. In one example, a tag is created without using the watermarks on a device (e.g., on the first or primary device that presents the content to the user) that is capable of providing a running time code for the content that is presented. To this end, the device may include a counting or a measuring device, or software program, that keeps track of content timeline or frame numbers as the program is presented. Such a counting or measuring mechanism can then provide the needed time codes (e.g., relative to the start of the program, or as an absolute date-time value) when a tag is created. The tag server can then use an electronic program guide and/or other source of program schedule information to identify the content, and to estimate the point in content timeline at which the tag was created. In one particular example, a tag server identifies the content and estimates the section of the content that is presented by a first device that is an Internet-connected TV when the first device sends the local time, service provider and channel information to the tag server. In another exemplary embodiment, upon creating a tag, the tag server is provided with a digest (e.g., a fingerprint, a hash code, etc.) that identifies the content segment that is being tagged. The tag server can then use the digest to match against a digest database to identify the content and to locate the point within the content timeline at which the tag was created. Once the tag location within the content timeline is identified, the tag server can map the content to the corresponding CID, and map the tag location(s) to the corresponding TC(s) using the stored CID and TC values at the digest database.

In some scenarios, a user may control content playback using one or more of the following functionalities: pause, fast forward, reverse, forward jump, backward jump, resume, stop, and the like. These functionalities are often provided for pre-recorded content that is, for example, stored on a physical storage medium, in files or on a DVR, during streaming content replays, and some video-on-demand presentations. In these scenarios, a user may create a tag by manually specifying the start and optional end points in content timeline during content review or re-plays. Generation of tags in these scenarios can be done in a similar fashion as the process previously described in connection with tags created prior to content distribution.

In accordance with some embodiments, the author of a tag may edit the tag before publishing it. Once a tag is published (i.e., it becomes available to others), such a tag can be removed or, alternatively, expanded by its author. Once a tag is published on a tag server, a unique identifier is assigned to the published tag. In one example, such a unique identifier is a URL on the Web or in the domain of the tagging system.

According to some embodiments, a tag is linked to one or more other tags when the tag is created, or after the tag is created or published. Tag links may be either created by the user or by a tag server based on a predefined relationship. For example, when a tag is created based on an existing tag (e.g., a user's response to another user's comment or question), the new tag can be automatically linked to the existing tag through a “derivative” (or ‘based-on”) relationship. In another example, a “similar” relationship can be attributed to tags that correspond to similar scenes in the same or different content. In another example, a “synchronization” relationship can be attributed to tags that correspond to the same scene, conversation or action in different instances of the same content. For instance, if the same content (e.g., having the same title) is customized into multiple versions for distribution through separate distribution channels (e.g., over-the-air broadcast versus DVD-release) or for distribution in different countries, each of the tags associated with one version can be synchronized with the corresponding tags of another version through a “synchronization” relationship. Such links may be stored in the tag's header section, and/or stored and maintained by tag servers, as discussed later.

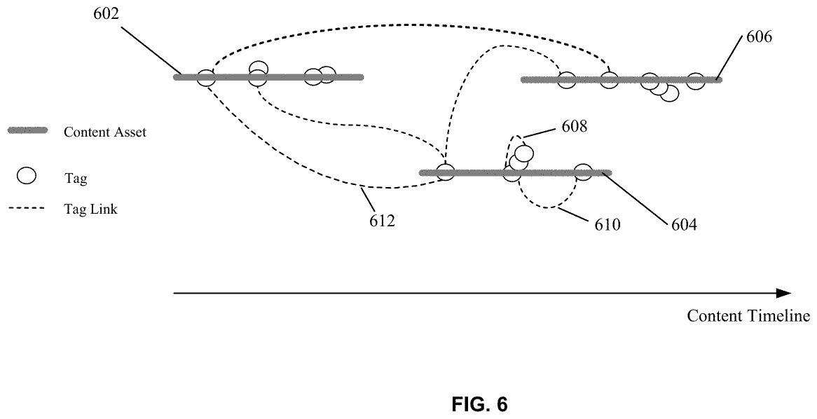

FIG. 6 illustrates a plurality of tag links in accordance with an exemplary embodiments. In the exemplary diagram of FIG. 6, three content asset timelines 602, 604 and 606 are illustrated, each having a plurality of associated tags, illustrated by circles. The content asset timelines 602, 604 and 606 may correspond to different contents or to different instances of the same content. Some of the tags associated with each of the three content asset timelines 602, 604 and 606 are linked to other tags in the same or different content asset. For example, assuming content asset timeline 602 and content asset timeline 604 correspond to different instances (e.g., different regional versions of the same movie) of the same content, and content asset timeline 606 corresponds to an entirely different content, link 608 may represent a “derivative” relationship, designating a later-created tag as a derivative of an earlier-created tag. Further, link 610 may represent a “similar” relationship that designates two tags as corresponding to similar scenes, and link 612 may represent a “synchronization” relationship that designates two tags as corresponding to the same scene of content asset timeline 602 and content asset timeline 604. It should be noted that it is possible for a link to represent more than one type of relationship.

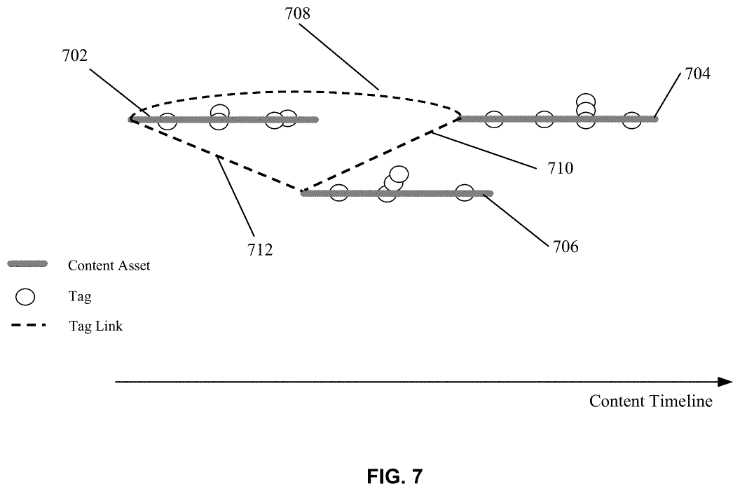

According to some embodiments, another type of connection indirectly links one or more tags that are associated with different versions of the same work. These indirect links are not stored as part of a tag, but are created and maintained by the tag servers. For example, a movie may be edited and distributed in multiple versions (e.g., due to the censorship guidelines in each country or distribution channel), each version having a unique content identifier (CID). Links between such different versions of the content can be established and maintained at the tag server. In some cases, such links are maintained by a linear relationship between the TCs in one version and the TCs in another version. The tag server may also maintain a mapping table between the TCs embedded in different versions of the same work. Thus, for example, a tag associated with a scene in one version can be connected with a tag associated with the same scene in another version without having an explicit link within the tags themselves. FIG. 7 illustrates three exemplary indirect links 708, 710 and 712 that link the content versions represented by timeline 702, 704 and 706.

As noted earlier, the header section of a tag may contain a tag address. A user may directly access a tag by specifying the tag address. Users may also search for tags using one or more additional fields in the tag header section, such as the demographic information of tag creators, links created by tag servers, and other criteria. For example, a user may search for tags using one or more of the following criteria: tags created by my friends in my social networks, or my neighborhood; top 10 tags created in the last hour, and top 20 tags created for a movie title across all release windows. Users can further browse through the tags according to additional criteria, such as based on popularity of the tags (today, this week or this month) associated with all content assets in the tagging system or a specific content asset, based on chronological order of tags associated with a show before selective viewing of content, and the like.

According to some embodiments, tags can be presented in a variety of forms, depending on many factors, such as based on the screen size, whether synchronous or asynchronous presentation of tags with main content is desired, based on the category of content assets, etc. In some examples, one or more of: presence of tags, density of tags (e.g., number of tags in a particular time interval), category of tags and popularity of tags can be presented in the content playback timeline. In other examples, tags may be presented as visual or audible representations that are noticeable or detectable by the user when the main content playback reaches the points where tags are present. For instance, such visual or audible representations may be icons, avatars, content on a second window, overlays or popup windows. In still other examples, tags can be displayed as a list that is sorted according to predefined criteria, such as chronological order, popularity order and the like. Such a list can be presented synchronously with the content on, for example, the same screen or on a companion screen. According to other examples, tags can be displayed on an interactive map, where tags are represented by icons (e.g., circles) and links (relationships) between tags are represented by lines connecting the icons together. In these examples, tag details can be displayed by, for instance, clicking on the tag icon. Further, such a map can be zoomed in or out. For example, when the map is zoomed out to span a larger extent of the content timeline, only a subset of the tags within each particular timeline section may be displayed based on predefined criteria. For example, only tags above a certain popularity level are displayed, or only the latest tags are presented to avoid cluttering of the display. Such an interactive tag map facilitates content discovery and selective viewing of contents by a user. It should be noted that the tags may be presented using any one, or combinations, of the above example representation techniques.

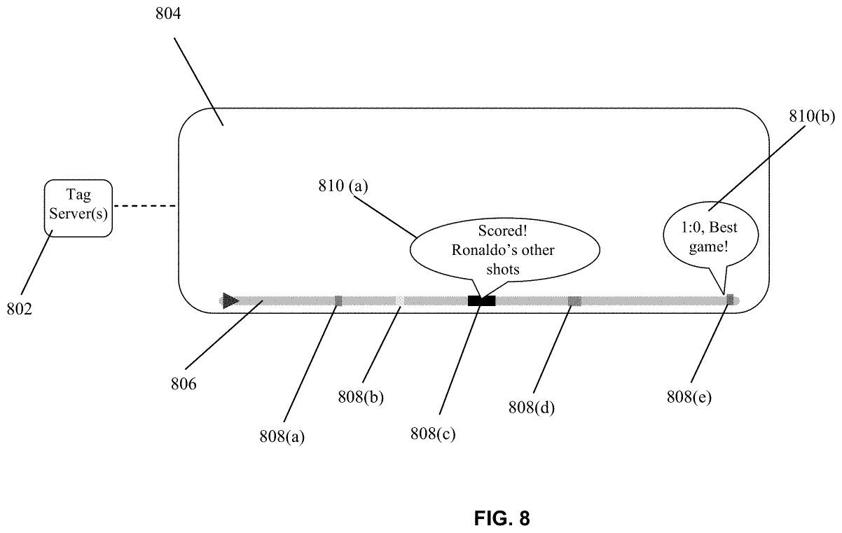

FIG. 8 illustrates a layout of a plurality of tags on a content timeline in accordance with an example embodiment. In FIG. 8, the main content is presented on a portion of a screen 804 of a device, such as a tablet, a smartphone, a computer monitor, or a television. Such a device is in communication with one or more tag servers 802. The horizontal bar 806 at the bottom of the screen 804 represents the content timeline. A user can have the ability to zoom in or out on the content timeline, thereby selecting to view the content timeline and the associated tags with different levels of granularity. FIG. 8 depicts five vertical bars 808(a) through 808(e) on the content timeline 806 that represent the presence of one or more tags. The widths of vertical bars 808(a) through 808(e) are indicative of the number tags in the corresponding sections of the content. For example, there are more tags associated with vertical bar 808(c) than those associated with vertical bar 808(a). Further, the coloring or intensity scheme of the tags can represent particular levels of interest (e.g., popularity) of the associated tags. For example, the color red or a darker shade of gray can represent tags with the highest popularity rating, whereas the color yellow or a lighter shade of gray can represent tags with the lowest popularity rating. In this context, the vertical bar 808(c) in the exemplary diagram of FIG. 8 corresponds to content segments that are associated with the most popular tags, as well as the most number of tags.

In one exemplary embodiment, when a pointer (e.g., a mouse, a curser, etc.) is moved to hover over a vertical bar 808(a) through 808(e), a text 810(a), 810 (b) can be displayed that summarizes the contents of the associated tags (e.g., “Scored! Ronaldo's other shots”). When the pointer is used to click on a vertical bar 808(a) through 808(e), additional details associated with the tags are displayed. These additional details can, for example, be displayed on a larger area of the screen 804 and/or on another screen if such a companion screen is available. Communications to/from the companion screen can be conducted through any number of communication techniques and protocols such as Wifi, infra signaling, acoustic coupling, and the like. The exemplary layout of FIG. 8 can facilitate viewing and interaction with the tags in cases where a limited screen space is available, or when minimal viewing disturbance of the main content is desired.

In accordance with the disclosed embodiments, tags can be stored in centralized servers and accessed by all users for a variety of use cases. For example, a user can use the tagging system for content discovery (e.g., selecting a content with the most popular tags or most number of tags), or use the tags of a known content to obtain additional information, features and services.

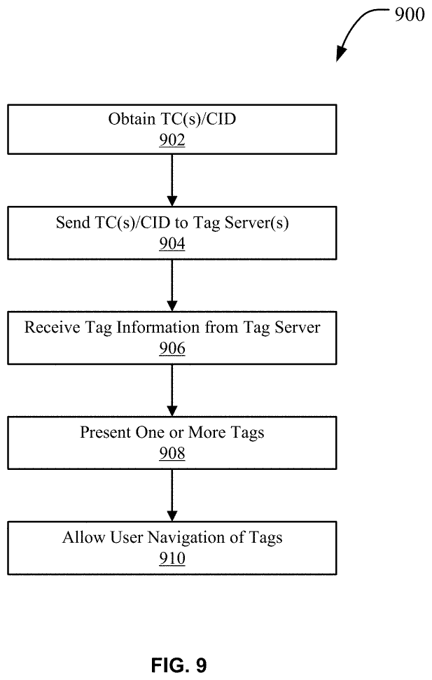

As noted earlier, in some embodiments, tags are used in synchronization with a main content. In particular, such synchronized tags can be displayed on a second screen in synchronization with the segments of the main content that is presented on a first screen. FIG. 9 illustrates a set of operations 900 that can be carried out for synchronous usage of tags in accordance with an example embodiment. The operations 900 can, for example, be carried out at a first device that is presenting a main content, such as device 402 that is shown in FIG. 4, and/or at a second device, such as device 306 that is shown in FIG. 3, that is complementary to the first device 302. At 902, one or more time codes (TCs) associated with content segments that are presented, and in some embodiments, a content identifier (CID), are obtained. As was noted earlier, in some embodiments, the content identifier can be obtained at the tag server based on the time code using, for example, an electronic program guide. The operations at 902 can be carried out by, for example, an application that is running on a second device that is configured to receive at least a portion of the content that is presented by a first device.

At 904, the CID and TC(s) are sent to one or more tag servers. The operations at 904 can also include an explicit request for tags associated with content segments identified by the CID and the TC(s). Alternatively, or additionally, a request for tags may be implicitly signaled through the transmission of the CID and TC(s). At 906, tag information is received from the server. Depending on implementation choices selected by the application and/or the user, connection capabilities to the server, and the like, the tag information can include a only a portion of the tag or the associated meta data, such as all or part of tag headers, listing, number, density, or other high level information about the tags. Alternatively, or additionally, the information received at 906 can include more comprehensive tag information, such as the entire header and body of the corresponding tags.

Referring back to FIG. 9, at 908, one or more tags are presented. The operations at 908 can include displaying of the tags on a screen based on the received tag information. For example, the content of tags may be presented on the screen, or a representation of tag characteristics, such as a portion of the exemplary layout of FIG. 8, may be presented on the screen. At 910, a user is allowed to navigate and use the displayed tags. For example, a user may view detailed contents of a tag by clicking on a tag icon, or a create new tag that can be linked to an existing tag that is presented. Further, the presented tags may provide additional information and services related to the content segment(s) that are being viewed.

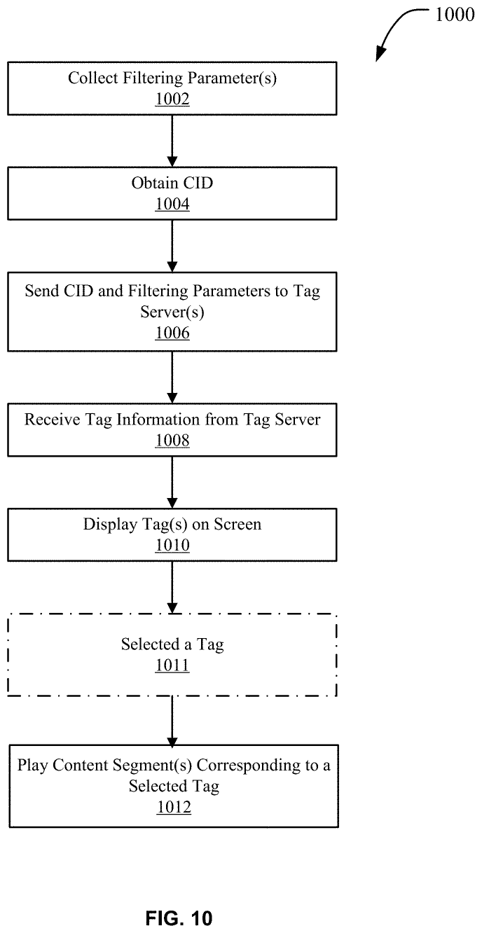

In some example embodiments, tags are used to allow selective reviewing of content. In these examples, before and during viewing of a recorded content, a user may want to selectively view the portions that have been tagged. To this end, the user may browse the tags associated with a content asset, select and review a tag, and jump to the content segment that is associated with the viewed tag. FIG. 10 illustrates a set of operations 1000 that can be carried out to allow selective reviewing of tags in accordance with an exemplary embodiment. The operations 1000 can, for example, be carried out at a first device that is presenting a main content, such as device 402 that is shown in FIG. 4, and/or at a second device, such as device 306 that is shown in FIG. 3, that is complementary to the first device 302. At 1002, one or more filtering parameter(s) are collected. For example, the filtering parameters can reflect a user's selection for retrieval of tags that are created by his/her friends on a social network (e.g., Facebook friends). At 1004, a content identifier (CID) associated with a content of interest is obtained. In some embodiments, the operations at 1004 are performed optionally since the CID may have previously been obtained from the content that is presented. At 1006, the CID and the filtering parameter(s) are sent to one or more tag servers. It should be noted that the CID may have been previously transmitted to the one or more tag servers upon presentation of the current content to the user. In these scenarios, the operations at 1006 may only include the transmission of filtering parameters along with an explicit or implicit request for tag information for selective content review. At 1008, tag information is received from the tag server. The received tag information conforms to the filtering criteria specified by the filtering parameters.

Continuing with the operations 1000 of FIG. 10, at 1010, one or more tags are displayed on a screen. As noted earlier, such tags may be displayed on a screen of a first device, or on a second device, using one of the preferred (e.g., user-selectable) presentation forms. The user can review the contents of the presented tags and select a tag of interest, as shown at 1011 using the dashed box. Such a selection can be carried out, for example, by clicking on the tag of interest, by marking or highlighting the tag of interest, and the like. At 1012, the content segment(s) corresponding to the selected tag is automatically presented to the user. The user may view such content segment(s) either on the screen on which the tag was selected, or on a different screen and/or window. The user may view content segments for the duration of start and end point of the selected tag, may continue viewing the content from the starting point of the selected tag, and/or may interrupt viewing of the current segments by stopping playback or by selecting other tags.

In some example embodiments, tags are used to allow content discovery. In these examples, a user can discover the content and receive recommendations through browsing and searching of tags. In one example, a user can be presented with a list of contents (or a single content) shown on today's television programs which have been tagged the most. In this example, upon receiving a request from a user device, the tag server may search the tag database to obtain tags that are created today for all content assets so as to allow the user to search and browse through those tags associated with the selected content(s). In another example, a user can be presented with a list of movies (or a single movie) that are currently shown in theaters which have been tagged with the highest favorite votes. In this example, upon receiving a request from a user device, the tag server may search the tag database to obtain tags that are created only for the content assets that are shown in theaters according with the requested criteria. In another example, a user can be presented with a list of contents (or a single content) that are shown on today's television programs which have been tagged by one or more friends in the user's social network. In this example, upon receiving a request from a user device, the tag server may search the tag database to obtain tags that conform to the requested criteria.

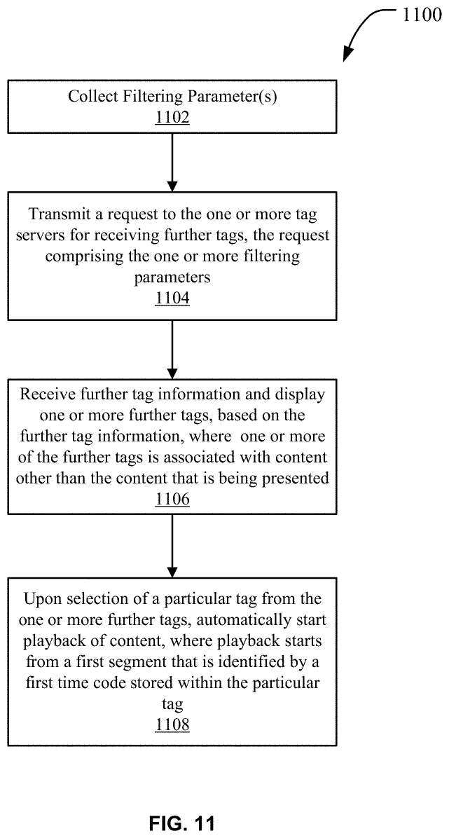

FIG. 11 illustrates a set of exemplary operations 1100 that can be carried out to perform content discovery in accordance with an exemplary embodiment. At 1102, one or more filtering parameters are collected. These parameters, as described above, restrict the field of search at the tag servers. At 1104, a request is transmitted to the one or more tag servers for receiving additional tags. Such a request includes the one or more above mentioned filtering parameters. Further, in scenarios where a content is being currently presented to the user, such a request can further include a specific request for tags associated with content other than the content that is presented. At 1106, further tag information is received and, based on the further tag information, one or more further tags associated with content (e.g., other than the content that is presented) are displayed. At 1108, upon selection of a particular tag from the one or more further tags, playback of content is automatically started. Such a playback starts from a first segment that is identified by a first time code stored within the particular tag.

According to some embodiments, content discovery may be additionally, or alternatively, performed through navigating the links among tags. For example, a tag that relates to a particular shot by a particular soccer player can include links that allows a user to watch similar shots by the same player in another soccer match.

In some example embodiments, tags are used to provide group and/or personal content annotations. For example, the audio portion of an audiovisual content may be annotated to provide significant added value in educational applications such as distance learning and self-paced asynchronous e-learning environments. In some embodiments, tag-based annotations provide contextual and personal notes and enable asynchronous collaboration among groups of learners. As such, students are not limited to viewing the content passively, but can further share their learning experience with other students and with teachers. Additionally, using the tags that are described in accordance with the disclosed embodiments, teachers can provide complementary materials that are synchronized with the recorded courses based on students' feedback. Thus, an educational video content is transformed into an interactive and evolving medium.

In some examples, private tags are created by users to mark family videos, personal collections of video assets, enterprise multimedia assets, and other content. Such private tags permanently associate personal annotations to the contents, and are only accessible to authorized users (e.g., family members or enterprise users). Private tags can be encrypted and stored on public tag servers with access control and authentication procedures. Alternatively, the private tags can be hosted on personal computers or personal cloud space for a family, or an enterprise-level server for an organization.

In some example embodiments, tags are used to provide interactive commercials. In particular, the effectiveness of an advertisement is improved by supplementing a commercial advertisement with purchase and other information that are included in tags on additional screens or in areas on the same screen that the main content/commercial is presented. A tag for such an application may trigger an online purchase opportunity, may allow the user to browse and replay the commercials, to browse through today's hot deals, and/or to allow users to create tags for a mash-up content or alternative story endings. In this context, a mash-up is a content that is created by combining two or more segments that typically belong to different contents. Tags associated with a mash-up content can be used to facilitate access and consumption of the content. In addition, advertisers may sponsor tags that are created before or after content distribution. Content segments associated with specific subjects (e.g., scenes associated with a new car, a particular clothing item, a drink, etc.) can be sold to advertisers through an auction as a tag placeholder. Such tags may contain scripts which enable smooth e-commerce transactions.

In some example embodiments, tags can be used to facilitate social media interactions. For example, tags can provide time-anchored social comments across social networks. To this end, when a user publishes a tag, such a tag is automatically posted on the user's social media page. On the other hand, tags created or viewed by a user can be automatically shared with his/her friends in the social media, such as Facebook and Twitter.

In some example embodiments, tags are used to facilitate collection and analysis of market intelligence. In particular, the information stored in, and gathered by, the tag servers not only describes the type of content and the timing of the viewing of content by users, but this information further provides intelligence as to consumers' likes and dislikes of particular content segments. Such fine-granularity media consumption information provides unprecedented level of detail regarding the behavior of users and trends in content consumption that can be scrutinized using statistical analysis and data mining techniques. In one example, content ratings can be provided based on the content identifier (CID) and time code (TC) values that are provided to the tag servers by clients during any period of time, as well as based on popularity rating of tags. In another example, information about consumption platforms can be provided through analyzing the tags that are generated by client devices. In yet another example, the information at the tag servers can be used to determine how much time consumers spend on: content consumption in general, on consumption of specific contents or types of contents, and/or on consumption of specific segments of contents.

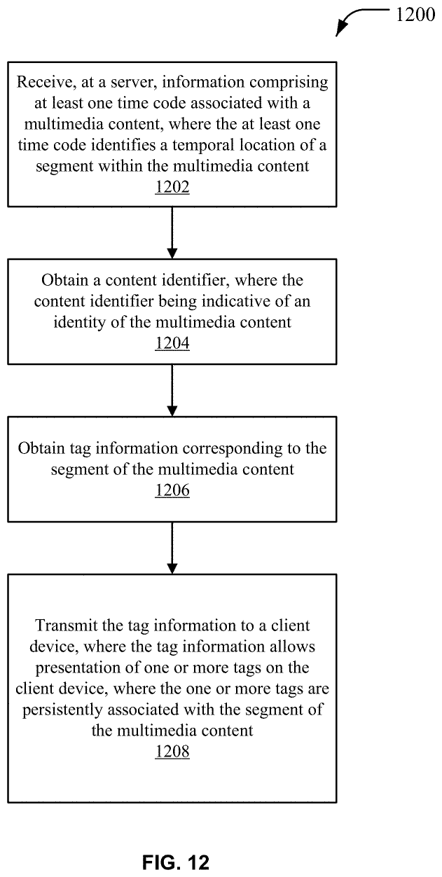

FIG. 12 illustrates a set of operations 1200 that can be carried out at a tag server in accordance with an exemplary embodiment. The operations 1200 can, for example, be carried out in response to receiving a request for “synchronizing” tags by a client device. At 1202, information comprising at least one time code associated with a multimedia content is received. The at least one time code identifies a temporal location of a segment within the multimedia content. At 1204, a content identifier is obtained, where the content identifier is indicative of an identity of the multimedia content. In some embodiments, the content identifier is obtained from the information that is received at 1202. In some embodiments, the content identifier is obtained using the at least one time code and a program schedule. At 1206, tag information corresponding to the segment of the multimedia content is obtained and, at 1208, the tag information is transmitted to a client device, where the tag information allows presentation of one or more tags on the client device, and the one or more tags are persistently associated with the segment of the multimedia content

It is understood that the various embodiments of the present disclosure may be implemented individually, or collectively, in devices comprised of various hardware and/or software modules, units and components. In describing the disclosed embodiments, sometimes separate components have been illustrated as being configured to carry out one or more operations. It is understood, however, that two or more of such components can be combined together and/or each component may comprise sub-components that are not depicted. Further, the operations that are described in the present application are presented in a particular sequential order in order to facilitate understanding of the underlying concepts. It is understood, however, that such operations may be conducted in a different sequential order, and further, additional or fewer steps may be used to carry out the various disclosed operations.

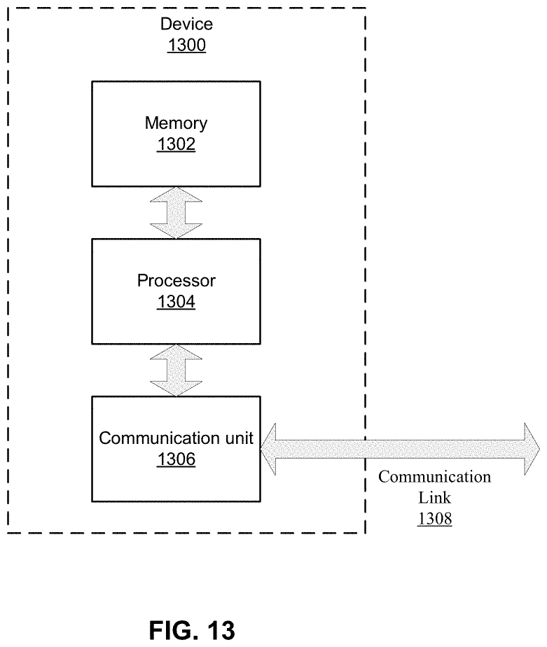

In some examples, the devices that are described in the present application can comprise at least one processor, at least one memory unit that are communicatively connected to each other, and may range from desktop and/or laptop computers, to consumer electronic devices such as media players, mobile devices, televisions and the like. For example, FIG. 13 illustrates a block diagram of a device 1300 within which various disclosed embodiments may be implemented. The device 1300 comprises at least one processor 1302 and/or controller, at least one memory 1304 unit that is in communication with the processor 1302, and at least one communication unit 1306 that enables the exchange of data and information, directly or indirectly, through the communication link 1308 with other entities, devices, databases and networks. The processor 1302 can, for example, be configured to perform some or all of watermark extraction and fingerprint computation operations that were previously described. The communication unit 1306 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 1300 that is depicted in FIG. 13 may be integrated into as part of a content handling device to carry out some or all of the operations that are described in accordance with the disclosed embodiments. For example, the device 1300 can be incorporated as part of a first device 302 or the second device 306 that are depicted in FIG. 3.

In some embodiments, the device 1300 of FIG. 13 may also be incorporated into a device that resides at a database or server location. For example, the device 1300 can be reside at one or more tag server(s) 308 that are depicted in FIG. 3 and be configured to receive commands and information from users, and perform various operations that are described in connection with tag servers in the present application.

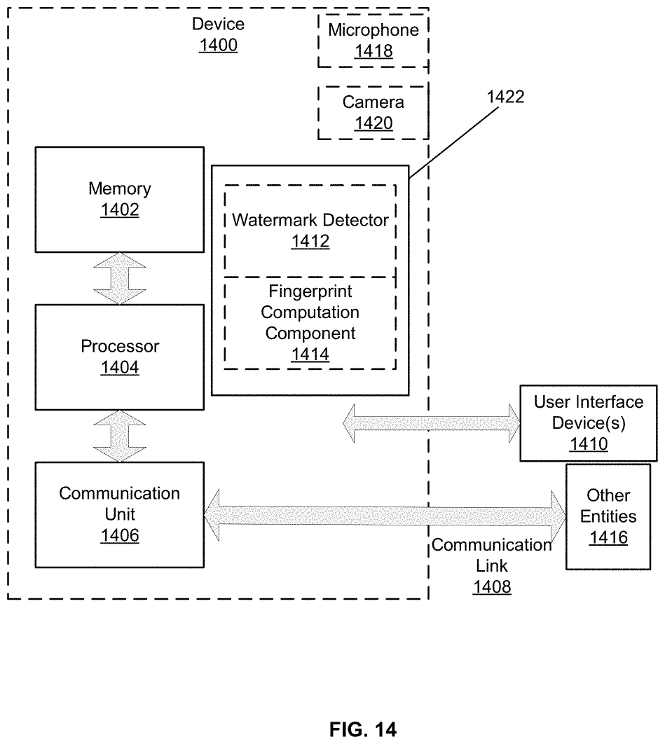

FIG. 14 illustrates a block diagram of a device 1400 within which certain disclosed embodiments may be implemented. The exemplary device 1400 that is depicted in FIG. 14 may be, for example, incorporated as part of the client devices 202(a) through 202(N) that are illustrated in FIG. 2, the first device 302 or the second device 306 that are shown in FIG. 3. The device 1400 comprises at least one processor 1404 and/or controller, at least one memory 1402 unit that is in communication with the processor 1404, and at least one communication unit 1406 that enables the exchange of data and information, directly or indirectly, through the communication link 1408 with at least other entities, devices, databases and networks (collectively illustrated in FIG. 14 as Other Entities 1416). The communication unit 1406 of the device 1400 can also include a number of input and output ports that can be used to receive and transmit information from/to a user and other devices or systems. The communication unit 1406 may provide wired and/or wireless communication capabilities in accordance with one or more communication protocols and, therefore, it may comprise the proper transmitter/receiver, antennas, circuitry and ports, as well as the encoding/decoding capabilities that may be necessary for proper transmission and/or reception of data and other information. In some embodiments, the device 1400 can also include a microphone 1418 that is configured to receive an input audio signal.

In some embodiments, the device 1400 can also include a camera 1420 that is configured to capture a video and/or a still image. The signals generated by the microphone 1418 and the camera 1420 may further undergo various signal processing operations, such as analog to digital conversion, filtering, sampling, and the like. It should be noted that while the microphone 1418 and/or camera 1420 are illustrated as separate components, in some embodiments, the microphone 1418 and/or camera 1420 can be incorporated into other components of the device 1400, such as the communication unit 1406. The received audio, video and/or still image signals can be processed (e.g., converted from analog to digital, color corrected, sub-sampled, evaluated to detect embedded watermarks, analyzed to obtain fingerprints, etc.) in cooperation with the processor 1404. In some embodiments, instead of, or in addition to, a built-in microphone 1418 and camera 1420, the device 1400 may be equipped with an input audio port and an input/output video port that can be interfaced with an external microphone and camera, respectively.

The device 1400 also includes an information extraction component 1422 that is configured to extract information from one or more content segments that enables determination of CID and/or time codes, as well as other information. In some embodiments, the information extraction component 1422 includes a watermark detector 1412 that is configured to extract watermarks from one or more components (e.g., audio or video components) of a multimedia content, and to determine the information (such as CID and time codes) carried by such watermarks. Such audio (or video) components may be obtained using the microphone 1418 (or camera 1420), or may be obtained from multimedia content that is stored on a data storage media and transmitted or otherwise communicated to the device 1400. The information extraction component 1422 can additionally, or alternatively include a fingerprint computation component 1414 that is configured to compute fingerprints for one or more segments of a multimedia content. The fingerprint computation component 1414 can operate on one or more components (e.g., audio or video components) of the multimedia content to compute fingerprints for one or more content segments, and to communicate with a fingerprint database. In some embodiments, the operations of information extraction component 1422, including the watermark detector 1412 and fingerprint computation component 1414, are at least partially controlled by the processor 1404.

The device 1400 is also coupled to one or more user interface devices 1410, including but not limited to a display device, a keyboard, a speaker, a mouse, a touch pad, a motion sensors, a remote control, and the like. The user interface device(s) 1410 allow a user of the device 1400 to view, and/or listen to, multimedia content, to input information such a text, to click on various fields within a graphical user interface, and the like. While in the exemplary block diagram of FIG. 14 the user interface devices 1410 are depicted as residing outside of the device 1400, it is understood that, in some embodiments, one or more of the user interface devices 1410 may be implemented as part of the device 1400. Moreover, the user interface devices may be in communication with the device 1400 through the communication unit 1406.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

A content that is embedded with watermarks in accordance with the disclosed embodiments may be stored on a storage medium and/or transmitted through a communication channel. In some embodiments, such a content that includes one or more imperceptibly embedded watermarks, when accessed by a content handling device (e.g., a software or hardware media player) that is equipped with a watermark extractor and/or a fingerprint computation component, can trigger a watermark extraction or fingerprint computation process that further trigger the various operations that are described in this application.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1-20. (canceled)

21. A device for navigation, creation or modification of tags associated with a content, the device comprising:
an information extraction component, comprising:
a watermark extractor configured to extract one or more messages from the content; and
a fingerprint computation unit in communication with a fingerprint database and configured to compute fingerprints from the content, the watermark extractor and the fingerprint computation unit implemented at least partially in hardware;
a processor; and
a memory comprising instructions stored thereon, the instructions upon executed by the processor configuring the device to:
receive the content;
compute a fingerprint using at least a portion of a first segment of the content;
obtain content identification information and a time code value associated with the at least a portion of the first segment of the content;
extract a watermark message from the content, the watermark message including identifier and timing information;
transmit a request to a tag server for acquiring one or more tags based on the content identification information and the time code obtained based on the fingerprint;
receive the one or more tags from the tag server, wherein the one or more tags are persistently associated with one or more segments of the content that span a plurality of temporal sections; and
automatically provide one or more presentations upon extraction of the watermark message including the identifier and timing information.

22. The device of claim 21, wherein the one or more tags enables identification of one or more time points in a timeline of the content.

23. The device of claim 21, wherein the extracted watermark message is associated with a particular time code within a timeline of the content.

24. The device of claim 21, wherein the instructions upon executed by the processor configures the device to obtain the content identification information and the time code value by transmitting the computed fingerprint to a fingerprint database, wherein the fingerprint database comprises stored fingerprints and associated content identification information for a plurality of contents to allow determination of the content identification information and the time code by comparing the computed fingerprint with the stored fingerprints.

25. The device of claim 21, wherein each of the one or more tags includes one or more of the following:
a tag category field;
a name of an author associated with the tag;
an identifier field; or
a privacy field.

26. The device of claim 21, wherein the instructions upon executed by the processor further configures the device to present the one or more tags on a graphical user interface as one or more corresponding icons that are superimposed on a timeline of the content.

27. The device of claim 26, wherein at least one icon is connected to at least another icon using a connection that is representative of a link between the at least one icon and the at least another icon.

28. The device of claim 21, wherein each of the one or more tags comprises a header section that includes a tag address that uniquely identifies each tag.

29. The device of claim 21, wherein the one or more presentations includes an interactive opportunity presented in synchronization with the content for allowing a user of the device to provide an input based on the interactive opportunity.

30. The device of claim 21, wherein the processor executable code upon execution by the processor configures the processor to, upon receiving the one or more tags, to:
collect one or more filter parameters associated with the received tags;
transmit a request to the tag server, the request comprising the one or more filter parameters; and
receive further additional tags associated with another content different than the content.

31. A non-transitory computer medium including instructions stored thereupon, the instructions being executable to by a processor and comprising:
program code for receiving a content on an electronic device that is configured to present the content on a screen of the electronic device;
program code for extracting one or more messages from a content that is being received at the electronic device;
program code for obtaining one or more fingerprints from the content that is being received at the electronic device;
program code for communicating with a fingerprint database to transmit the fingerprints information obtained based on computing the one or more fingerprints to the fingerprint database, and to receive information associated with the content from the fingerprint database;
program code for computing a first fingerprint using at least a portion of a first segment of the content that is being received at the electronic device;
program code for obtaining content identification information and a time code value associated with the at least a portion of the first segment of the content by transmitting the computed first fingerprint to the fingerprint database, wherein the fingerprint database comprises stored fingerprints and associated content identification information for a plurality of contents to allow determination of the content identification information and the time code by comparing the computed fingerprint with the stored fingerprints;
program code for extracting a first watermark message from the content that is being received at the electronic device, the watermark message including identifier and timing information;
program code for transmitting a request to a tag server for acquiring one or more tags based on the content identification information and the time code obtained based on the first fingerprint;
program code for receiving the one or more tags from the tag server, wherein the one or more tags are persistently associated with one or more segments of the content that span a plurality of temporal sections; and
program code for automatically providing one or more presentations upon extraction of the watermark message including the identifier and timing information.

32. The non-transitory computer medium of claim 31, wherein the one or more tags enables identification of one or more time points in a timeline of the content.

33. The non-transitory computer medium of claim 31, wherein the extracted first watermark message is associated with a particular time code within a timeline of the content.

34. The non-transitory computer medium of claim 31, wherein each of the one or more tags includes one or more of the following:
a tag category field;
a name of an author associated with the tag;
an identifier field; or a privacy field.

35. The non-transitory computer medium of claim 31, wherein a start of play of the one or more presentations is determined based on a first time code associated with the extracted first watermark.

36. The non-transitory computer medium of claim 31, further comprising program code for presenting the one or more tags on a graphical user interface as one or more corresponding icons that are superimposed on a timeline of the content.

37. The non-transitory computer medium of claim 36, wherein at least one icon is connected to at least another icon using a connection that is representative of a link between the at least one icon and the at least another icon.

38. The non-transitory computer medium of claim 31, wherein each of the one or more tags comprises a header section that includes a tag address that uniquely identifies each tag.

39. The non-transitory computer medium of claim 31, wherein the one or more presentations includes an interactive opportunity presented in synchronization with the content for allowing a user of the device to provide an input based on the interactive opportunity.

40. The non-transitory computer medium of claim 31, further comprising program code for, upon receiving the one or more tags, collecting one or more filter parameters associated with the received tags, transmitting a request to the tag server, the request comprising the one or more filter parameters; and receiving further additional tags associated with another content different than the content that is being received by the electronic device.
